(19) United States
(12) Patent Application Publication
(10) Pub. No.: US 2026/0163405 A1
(43) Pub. Date: Jun. 11, 2026

(54) Multi-Device Wireless Charging Station

(71) Applicants: Kai Barnes, Glenn Heights, TX (US); Nneka Alston, Georgetown, TX (US)

(72) Inventors: Kai Barnes, Glenn Heights, TX (US); Nneka Alston, Georgetown, TX (US)

(21) Appl. No.: 19/171,443

(22) Filed: Apr. 7, 2025

Related U.S. Application Data
(60) Provisional application No. 63/730,136, filed on Dec. 10, 2024.

(51) Int. Cl. H02J 50/00; H02J 50/12; H02J 50/40; H02J 50/80; H02J 50/90

(52) U.S. Cl. CPC H02J 50/005; H02J 50/12; H02J 50/402; H02J 50/80; H02J 50/90

(57) ABSTRACT

The present invention is a multi-device wireless charging station designed to wirelessly charge multiple electronic devices, such as smartphones and tablets, simultaneously. The charging station features a frame which incorporates a plurality of charging compartments, each equipped with a wireless charger for inductive charging. Each compartment operates independently and includes customizable LED indicators for monitoring charging status and alerting users to overcharging or malfunctions. The charging station supports multiple wireless charging protocols, such as Qi, PMA, and AirFuel Resonant, ensuring compatibility with a wide range of devices. In one embodiment, the charging station includes removable dividers for adjustable slot sizing and a front sleeve to prevent device slipping, with non-slip legs ensuring stability on various surfaces.

### CROSS-REFERENCE TO RELATED APPLICATION

The present application claims priority to, and the benefit of, U.S. Provisional Application No. 63/730,136 which was filed on Dec. 10, 2024, and is incorporated herein by reference in its entirety.

### FIELD OF THE INVENTION

The present invention generally relates to wireless charging systems for mobile devices. More specifically, the invention relates to a multi-device wireless charging station designed to accommodate and wirelessly charge multiple electronic devices simultaneously. The wireless charging station features a lightweight and waterproof frame configured with multiple charging compartments, each equipped with a wireless charging pad embedded with a coiled transmitter for inductive charging. Each charging compartment operates independently, providing a designated space for charging smartphones, tablets, and other electronic devices. A power cord connects the station to a standard electrical outlet, enabling simultaneous operation of all compartments for efficient multi-device charging. Accordingly, the present disclosure makes specific reference thereto. Nonetheless, it is to be appreciated that aspects of the present invention are also equally applicable to other like applications, devices, and methods of manufacture.

### BACKGROUND

By way of background, charging mobile devices, such as cell phones, tablets, and other electronics, traditionally requires access to an electrical outlet and a compatible charging cable. The conventional approach often presents challenges for users who may not always have immediate access to an outlet or the required charging accessories. For instance, while traveling, individuals frequently find themselves without a way to recharge their devices, leading to situations where they may miss important phone calls, emails, text messages, or other critical communications.

Moreover, public charging stations, though increasingly common, remain unavailable in many locations, requiring users to depend on their personal charging equipment. The dependency can result in inconvenience, especially in scenarios where cables are misplaced, damaged, or forgotten. Additionally, the clutter and hassle of managing multiple charging cables for multiple devices further exacerbate the problem. Accordingly, individuals desire a versatile, cable-free, and user-friendly solution to simultaneously charge multiple devices efficiently and conveniently in various settings.

Therefore, there exists a long-felt need in the art for a multi-device wireless charging station that addresses the challenges of charging multiple devices simultaneously. There is a long-felt need for a solution that eliminates the dependency on individual charging cables and outlets. Additionally, there is a long-felt need for a system that provides a designated, independent charging space for each device. Furthermore, there is a long-felt need for a solution that incorporates advanced safety features such as overcharging protection, surge protection, and heat dissipation to prevent damage to devices during charging. More specifically, there exists a long-felt need in the art for a compact, portable charging station that can charge multiple devices wirelessly, simultaneously, and efficiently in homes, offices, and public spaces. Finally, there is a long-felt need for an innovative wireless charging system that is durable, easy to use, and capable of addressing the limitations of traditional charging methods.

The subject matter disclosed and claimed herein, in one embodiment, comprises a multi-device wireless charging station designed to wirelessly charge multiple mobile devices simultaneously. The charging station includes a frame made of waterproof and lightweight material, configured to accommodate a plurality of charging compartments. Each compartment includes a base embedded with a wireless charging pad, equipped with a coiled transmitter that generates an electromagnetic field to inductively charge mobile devices. The charging compartments are arranged in rows and columns and operate independently, enabling simultaneous charging of multiple devices. The charging station further includes an electric cord for connecting to a power outlet and customizable LED indicators that display the charging status of each device and signal overcharging or malfunction.

In this manner, the multi-device wireless charging station of the present invention fulfills the aforementioned needs by providing a highly efficient and organized solution for wirelessly charging multiple devices. The station provides independent charging compartments that enable users to charge different devices simultaneously without interference. The station provides safety features such as overcharging protection, surge protection, and heat dissipation for safety and longevity of both the charging station and the devices being charged. The charging station can be used in homes, offices, and public spaces. Additionally, the customizable LED indicators provide real-time updates on charging progress and device status. The station eliminates the need for individuals to locate individual electrical outlets and charging cables to charge their devices.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-device wireless charging station. The charging station includes a frame, the frame includes a plurality of charging compartments, each charging compartment is configured as a wireless charging pad, the wireless charging pad is equipped with an embedded coiled transmitter for generating an electromagnetic field to inductively charge a mobile device placed within the compartment, an electric cord is operatively connected to the frame for supplying power to the wireless charging pads in the charging compartments, wherein the charging station is capable of charging multiple mobile devices simultaneously, with each charging compartment operating independently.

In another aspect, a customizable LED indicator is associated with each charging compartment, the LED indicator is configured to indicate the charging status of a mobile device and provides alerts for overcharging or malfunction conditions.

In one embodiment, a wireless charging caddy for accommodating and charging multiple mobile devices is disclosed. The caddy includes a plurality of charging slots disposed within a frame, the frame including removable dividers configured to separate adjacent charging slots, the dividers being removable to adjust the size of the slots for accommodating different device dimensions, a wireless charging wall is disposed in each charging slot, the wall includes a plurality of wireless chargers configured to wirelessly charge devices using inductive coupling, a front sleeve extends from a base of the frame to prevent mobile devices from slipping or tipping during charging, and a power cord for connecting the caddy to an electric outlet to provide power to the wireless chargers.

In yet another aspect, a portable wireless charging station for charging electronic devices is disclosed. The charging station includes a plurality of charging compartments arranged in rows and columns, each charging compartment includes a wireless charger embedded in the base to facilitate inductive charging, an overcharging protection module is configured to stop energy flow when a device is fully charged, a surge protection module is configured to regulate voltage supply and prevent voltage spikes, a heat sink is configured to dissipate heat during the charging process to prevent overheating, wherein the charging station supports multiple wireless charging protocols and prevents charging if an incompatible device is placed in a compartment.

In still another embodiment, each charging compartment includes a heat sink disposed within the compartment to dissipate heat generated during the charging process, preventing overheating of both the wireless charging pad and the mobile device.

In yet another embodiment, the customizable LED indicators are configured to display different colors or flash patterns to indicate charging progress, overcharging prevention, or the detection of a malfunction within a specific charging slot.

In still yet another embodiment, the wireless charger embedded in each charging compartment supports multiple charging standards, including Qi, PMA, and AirFuel Resonant, to provide compatibility with a wide range of mobile devices.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of multi-device wireless charging station of the present invention in accordance with the disclosed architecture;

FIG. 2 illustrates a perspective view showing a plurality of tablets or phones placed within the charging caddy of FIG. 1 in accordance with the disclosed structure;

FIG. 3 illustrates a perspective view of another embodiment of the charging caddy of the present invention in accordance with the disclosed structure;

FIG. 4 illustrates a perspective view showing how a divider is removed from the charging caddy of FIG. 3 in accordance with the disclosed structure;

FIG. 5 illustrates a perspective view showing a plurality of mobile devices placed in the multi-device charging station in accordance with one embodiment of the present invention; and

FIG. 6 illustrates a block diagram showing various internal components used in each charging compartment or slot of the charging caddy of different embodiments of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multi-device wireless charging station that addresses the challenges of charging multiple devices simultaneously. There is a long-felt need for a solution that eliminates the dependency on individual charging cables and outlets. Additionally, there is a long-felt need for a system that provides a designated, independent charging space for each device. Furthermore, there is a long-felt need for a solution that incorporates advanced safety features such as overcharging protection, surge protection, and heat dissipation to prevent damage to devices during charging. More specifically, there exists a long-felt need in the art for a compact, portable charging station that can charge multiple devices wirelessly, simultaneously, and efficiently in homes, offices, and public spaces. Finally, there is a long-felt need for an innovative wireless charging system that is durable, easy to use, and capable of addressing the limitations of traditional charging methods.

The present invention, in one exemplary embodiment, is a portable wireless charging station for charging electronic devices. The charging station includes a plurality of charging compartments arranged in rows and columns, each charging compartment includes a wireless charger embedded in the base to facilitate inductive charging, an overcharging protection module is configured to stop energy flow when a device is fully charged, a surge protection module is configured to regulate voltage supply and prevent voltage spikes, a heat sink is configured to dissipate heat during the charging process to prevent overheating, wherein the charging station supports multiple wireless charging protocols and prevents charging if an incompatible device is placed in a compartment.

Reference will now be made in detail to the present preferred embodiments of the invention, examples of which are illustrated in the accompanying drawings. Wherever possible, the same reference numerals are used in the drawings and the description to refer to the same or like parts.

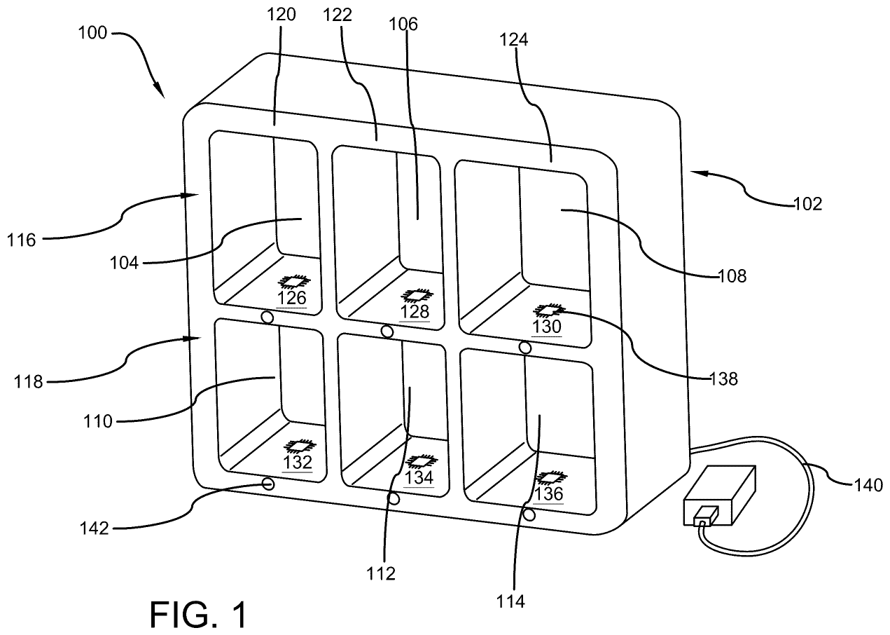

Referring initially to the drawings, FIG. 1 illustrates a perspective view of one embodiment of multi-device wireless charging station of the present invention in accordance with the disclosed architecture. The multi-device wireless charging station 100 of the present invention is designed to utilize wireless charging technology to power mobile devices like smartphones and tablets. The wireless charging station 100 is designed in the form of a portable device that can accommodate multiple devices simultaneously, providing an efficient solution for homes, offices, public spaces, gatherings, restaurants, hotels, conference centers, airports, et. al. to recharge a plurality of mobile devices.

More specifically, the charging station 100 includes a frame 102 which can be made of waterproof, lightweight material such as plastic, metal, or wood. The frame 102 can be of any geometric shape but is preferably generally rectangular or square (i.e., rectilinear). The frame 102 includes a plurality of charging compartments 104, 106, 108, 110, 112, 114 which are independently used for accommodating a single electronic mobile device for wireless charging. In the present embodiment, the compartments 104-114 are arranged in two rows 116, 118 and in three columns 120, 122, 124 (i.e., six charging compartments). It should be noted that any number of charging compartments in any arrangement can be disposed in the charging station 100.

The base of each charging compartment is in the form of a wireless charging pad and can be equipped with wireless charging technology. As illustrated, the bases 126, 128, 130, 132, 134, 136 of the respective charging components 104, 106, 108, 110, 112, 114 have a corresponding embedded coiled transmitter 138 therein to generate an electromagnetic field which inductively charges a wireless charging receiver of a mobile device when device is placed on the base of a charging compartment.

The charging caddy or station 100 has an electric cord 140 for supplying power to all, for example, six charging compartments within the charging station 100. It is to be appreciated that any number of multiple charging compartments can be included. The cord 140 can be used to connect to a conventional power outlet for receiving power. It should be noted that each compartment works independently, enabling multiple devices to charge simultaneously, and provides a designated space for each device. Each charging compartment can be designed to be compatible with other wireless charging protocols, such as PMA or AirFuel Resonant. Each charging compartment has an associated customizable LED indicator 142 for indicating charging process of a mobile device placed in the charging compartment. The LED indicator 142 can illuminate or flash to indicate overcharging or malfunction with the corresponding charging compartment. The charging station 100 also includes its own built-in rechargeable battery (not illustrated) for charging when the cord 140 is connected to a conventional power outlet. The battery functions as a power bank when the charging station 100 is disconnected from the power outlet in order to continue to charge the devices placed in the charging compartments.

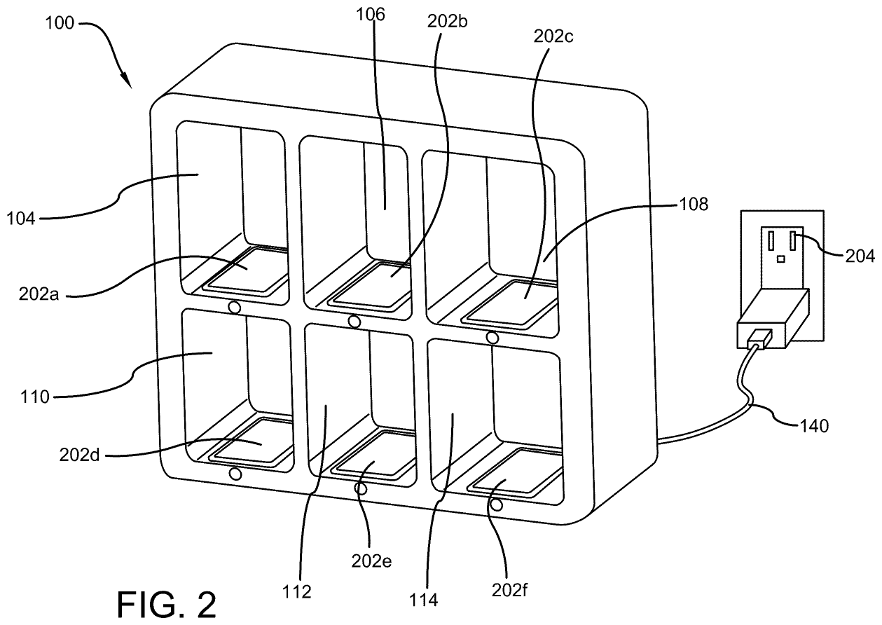

FIG. 2 illustrates a perspective view showing a plurality of tablets or phones placed within the charging caddy of FIG. 1 in accordance with the disclosed structure. As illustrated, a mobile phone 202a-f is placed in each of the charging compartments 104, 106, 108, 110, 112, 114 for independent recharging of the mobile phones. In the preferred embodiment, the charging caddy or station 100 is activated when the electric cord 140 is inserted into the power outlet 204 and electric power activates the coiled transmitter 138 embedded in the wireless charging pad of the base of the compartment. The status of each charging compartment is also illustrated by corresponding LED indicator 142.

In some embodiments, the caddy or station 100 includes a speaker for receiving voice commands and for voice operations, wherein each charging compartment may have a compartment number such as Compartment-1 or any other identifier. A user may provide voice commands such as “Check charging progress of Compartment 2” or “Turn off compartment 2” for remote monitoring and hands-free actuation of the caddy or station 100.

In one embodiment of the present invention, the charging station 100 prioritizes a predetermined charging compartment for prioritizing charging. As a non-limiting example, the compartment 102 can be a prioritized compartment and more power (i.e., all of the power) can be provided to the compartment 102 than the other charging compartments.

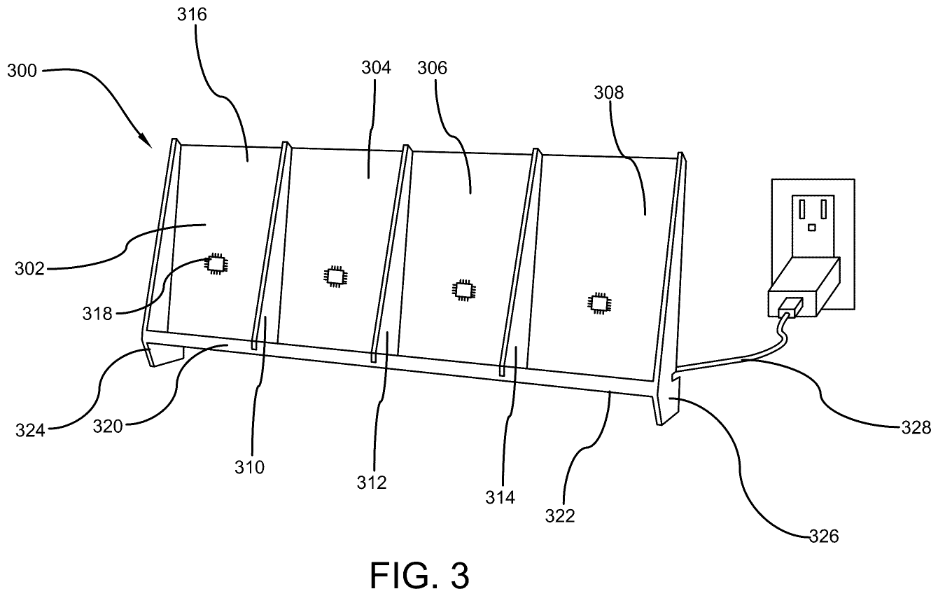

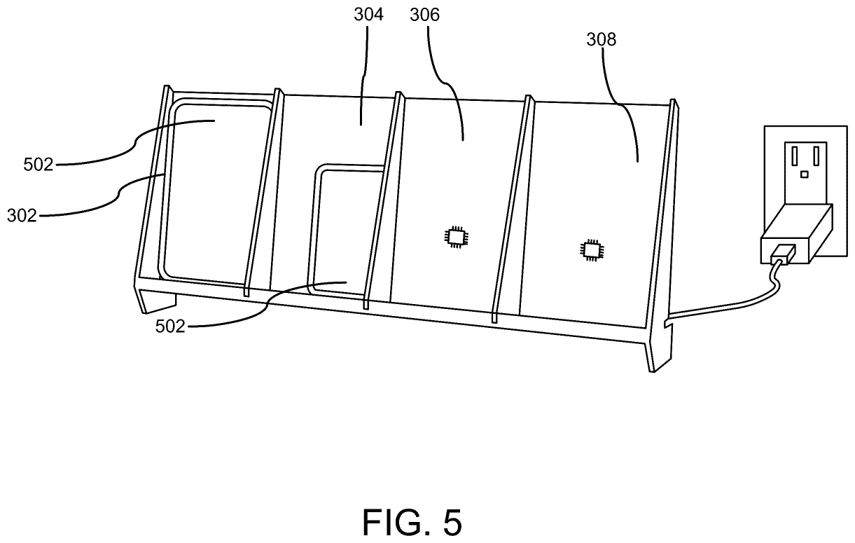

FIG. 3 illustrates a perspective view of another embodiment of the charging caddy of the present invention in accordance with the disclosed structure. In the present embodiment, the caddy 300 includes a plurality of wireless charging slots 302, 304, 306, 308 and each adjacent pair of the charging slots are separated by a divider as the dividers 310, 312, 314 are used for separating the slots. Each divider is removable for easy transportation and storage of the charging station 300. The charging station 300 includes a wireless charging wall 316 which includes a plurality of wireless chargers 318 disposed therein for providing wireless charging to the devices placed in the respective slots. The wall 316 is inclined, thereby enabling the mobile devices used with the slots to incline and adhere to the wireless chargers 318 as illustrated in FIG. 5.

A front sleeve 320 extends from the base 322 of the caddy 300 and prevents slipping and tipping of the mobile devices. The caddy 300 can be placed on any surface and has two non-slip legs 324, 326 for stability and support. The caddy 300 also includes a power cord 328 for supplying electric power to the caddy 300 for operation of the wireless chargers 318.

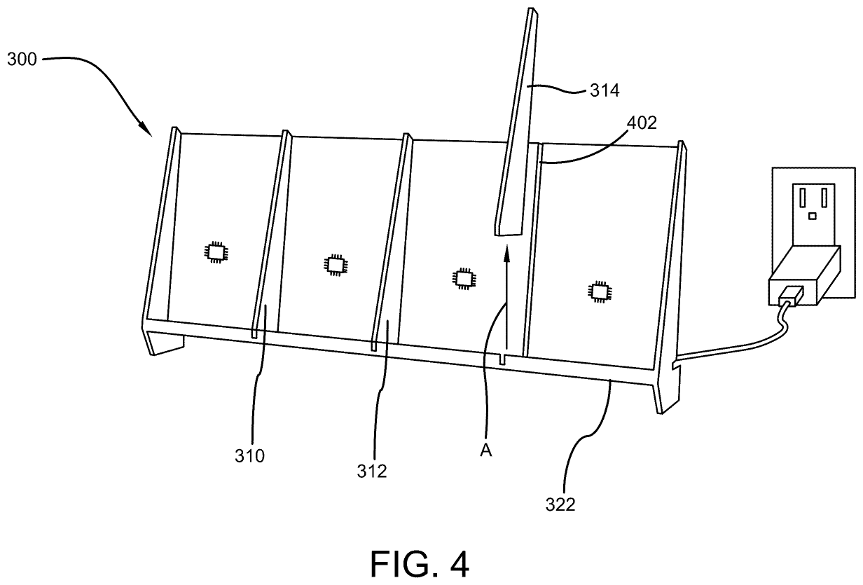

FIG. 4 illustrates a perspective view showing how a divider is removed from the charging caddy of FIG. 3 in accordance with the disclosed structure. As illustrated, the divider 314 is secured using a slit 402 and the divider 314 can be pulled up (shown by arrow A) to remove the divider 314 for accommodating different sized mobile devices. Each divider is secured using a corresponding slit and the dividers 310, 312, 314 help in keeping the mobile devices charged using the caddy 300 separate.

FIG. 5 illustrates a perspective view showing a plurality of different sized mobile devices placed in the multi-device charging station in accordance with one embodiment of the present invention. A mobile device 502 can be placed in each charging slot of the plurality of charging slots 302-308 such that the wireless charging receiver disposed in the mobile device 502 touches the charging wall 316 and the wireless charger 318, to recharge the battery of the mobile device 502 using induction.

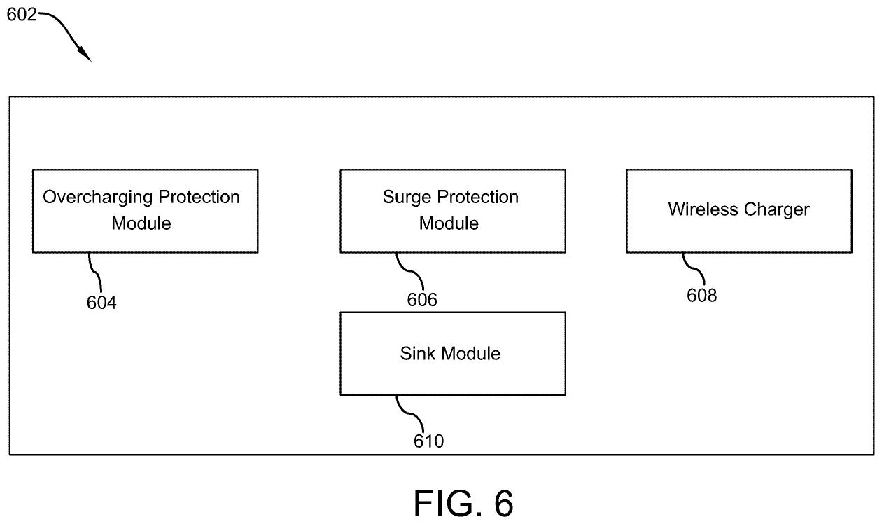

FIG. 6 illustrates a block diagram showing various internal components used in each charging compartment or slot of the charging caddy of different embodiments of the present invention. Each charging compartment 602 includes an overcharging protection module 604 which is adapted to prevent excessive energy flow once the mobile device placed in the compartment is fully charged. A surge protection module 606 regulates the voltage supply and protects the wireless charger 608 from voltage spikes. The wireless charger 608 is configured to use inductive coupling to transfer power wirelessly to the mobile device. The wireless charger 608 supports various charging protocols and does not provide charging if an incompatible mobile device is placed in the charging slot. A heat sink 610 is disposed in each compartment of the caddy to absorb heat and to prevent devices from overheating during charging.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-device wireless charging station”, “portable wireless charging caddy”, “charging caddy”, “charging station”, and “caddy” are interchangeable and refer to the portable multi-device wireless charging station 100, 300 of the present invention.

Notwithstanding the foregoing, the multi-device wireless charging station 100, 300 of the present invention can be of any suitable configuration as is known in the art without affecting the overall concept of the invention, provided that it accomplishes the above-stated objectives. One of ordinary skill in the art will appreciate that the multi-device wireless charging station 100, 300 as shown in the FIGS. are for illustrative purposes only, and that many other configurations of the multi-device wireless charging station 100, 300 are well within the scope of the present disclosure. Although the dimensions of the multi-device wireless charging station 100, 300 are important design parameters for user convenience, the multi-device wireless charging station 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable wireless charging station comprising:
a wireless charging station having a portable rectilinear frame; and
a plurality of charging compartments for charging a plurality of mobile devices simultaneously;
wherein said portable rectilinear frame having said plurality of charging compartments positioned in rows and columns;
wherein each of said plurality of charging compartments independently utilized for a single electronic mobile device for wireless charging;
wherein each of said plurality of charging compartments having a base comprising a wireless charging pad; and
further wherein each charging pad having an embedded coiled transmitter for generating an electromagnetic field to inductively charge a wireless charging receiver of each of said plurality of mobile devices.

2. The portable wireless charging station of claim 1 further comprising an electric cord for supplying power to said plurality of charging compartments from a power outlet.

3. The portable wireless charging station of claim 1, wherein each of said plurality of charging compartments independently charges each of said plurality of mobile devices.

4. The portable wireless charging station of claim 3, wherein each of said plurality of charging compartments compatible with wireless charging protocols selected from the group consisting of a Qi, a PMA, and an AirFuel Resonant.

5. The portable wireless charging station of claim 4, wherein each of said plurality of charging compartments having an LED indicator for indicating a charging process of each of said plurality of mobile devices placed in said plurality of charging compartments.

6. The portable wireless charging station of claim 5, wherein said wireless charging station having a speaker for receiving voice commands for hands-free actuation of said wireless charging station.

7. The portable wireless charging station of claim 6, wherein said wireless charging station selectively providing power to one compartment of said plurality of charging compartments.

8. The portable wireless charging station of claim 7, wherein said rectilinear frame having a plurality of rows and a plurality of columns.

9. The portable wireless charging station of claim 8, wherein said wireless charging station having a built-in rechargeable battery for charging when said electric cord is connected to the power outlet; and
further wherein said built-in rechargeable battery powers said wireless charging station when said wireless charging station is disconnected from the power outlet.

10. A portable wireless charging station comprising:
a wireless charging station having a portable rectilinear frame;
a plurality of charging compartments for charging a plurality of mobile devices simultaneously; and
a plurality of heat sinks;
wherein said portable rectilinear frame having said plurality of charging compartments positioned in rows and columns;
wherein each of said plurality of charging compartments independently utilized for a single electronic mobile device for wireless charging;
wherein each of said plurality of charging compartments having a base comprising a wireless charging pad;
wherein each charging pad having an embedded coiled transmitter for generating an electromagnetic field to inductively charge a wireless charging receiver of each of said plurality of mobile devices; and
further wherein each of said plurality of charging compartments having a heat sink from said plurality of heat sinks to absorb heat and to prevent said plurality of mobile devices from overheating during the wireless charging.

11. The portable wireless charging station of claim 10 further comprising an electric cord for supplying power to said plurality of charging compartments from a power outlet.

12. The portable wireless charging station of claim 10, wherein each of said plurality of charging compartments independently charges each of said plurality of mobile devices.

13. The portable wireless charging station of claim 12, wherein each of said plurality of charging compartments compatible with wireless charging protocols selected from the group consisting of a Qi, a PMA, and an AirFuel Resonant.

14. The portable wireless charging station of claim 13, wherein each of said plurality of charging compartments having an LED indicator for indicating a charging process of each of said plurality of mobile devices placed in said plurality of charging compartments.

15. The portable wireless charging station of claim 14, wherein said wireless charging station having a speaker for receiving voice commands for hands-free actuation of said wireless charging station.

16. The portable wireless charging station of claim 15, wherein said wireless charging station selectively providing power to one compartment of said plurality of charging compartments.

17. A portable wireless charging station comprising:
a wireless charging station having a portable rectilinear frame;
a plurality of charging compartments for charging a plurality of mobile devices simultaneously; and
a plurality of heat sinks;
wherein said portable rectilinear frame having said plurality of charging compartments positioned in rows and columns;
wherein each of said plurality of charging compartments independently utilized for a single electronic mobile device for wireless charging;
wherein each of said plurality of charging compartments having a base comprising a wireless charging pad;
wherein each charging pad having an embedded coiled transmitter for generating an electromagnetic field to inductively charge a wireless charging receiver of each of said plurality of mobile devices;
wherein each of said plurality of charging compartments having a heat sink from said plurality of heat sinks to absorb heat and to prevent said plurality of mobile devices from overheating during the wireless charging; and
further wherein each of said plurality of charging compartments having a selectively removable divider for accommodating different sized said plurality of mobile devices.

18. The portable wireless charging station of claim 17, wherein each of said plurality of charging compartments independently charges each of said plurality of mobile devices.

19. The portable wireless charging station of claim 18, wherein said wireless charging station having a speaker for receiving voice commands for hands-free actuation of said wireless charging station.

20. The portable wireless charging station of claim 19, wherein said wireless charging station selectively providing power to one compartment of said plurality of charging compartments.
